(19) United States
(12) Patent Application Publication
(10) Pub. No.: US 2024/0184994 A1
(43) Pub. Date: Jun. 6, 2024

(54) Autogenerated Language Model Notifications

(71) Applicant: Google LLC, Mountain View, CA (US)

(72) Inventors: Andrew Larsen Axley, Bend, OR (US); Jacob Antony Arnold, Boulder, CO (US); Ruochuan Zhang, Foster City, CA (US); Marci Meingast, San Francisco, CA (US); Erin Rebecca Griffiths, Santa Clara, CA (US); Eric Jeffrey Hayashi, Palo Alto, CA (US); Nahyun Kwon, Somerville, MA (US)

(73) Assignee: Google LLC, Mountain View, CA (US)

(21) Appl. No.: 18/441,268

(22) Filed: Feb. 14, 2024

Related U.S. Application Data
(60) Provisional application No. 63/551,586, filed on Feb. 9, 2024.

(51) Int. Cl. G06F 40/40; G06F 18/2413

(52) U.S. Cl. CPC G06F 40/40; G06F 18/2413

(57) ABSTRACT

This document describes systems and techniques directed at autogenerated language model notifications. In aspects, a device management system associated with a network of network-connected devices includes a prompt manager. The prompt manager obtains metadata associated with the network and integrates at least portions of data from the metadata into one or more templated prompts to create an instantiated prompt. The instantiated prompt can be transmitted to a language model to generate a language model output. The prompt manager may then provide, based on the language model output, a notification to a user associated with at least one network-connected device. Through such a technique, the prompt manager can improve user experience and facilitate user proactiveness managing their network of network-connected devices.

### CROSS-REFERENCE TO RELATED APPLICATION(S)

This application claims the benefit of U.S. Provisional Patent Application Ser. No. 63/551,586, filed on Feb. 9, 2024, the disclosure of which is incorporated by reference herein in its entirety.

### SUMMARY

This document describes systems and techniques directed at autogenerated language model notifications. In aspects, a device management system associated with a network of network-connected devices includes a prompt manager. The prompt manager obtains metadata associated with the network and integrates at least portions of data from the metadata into one or more templated prompts to create an instantiated prompt. The instantiated prompt can be transmitted to a language model to generate a language model output. The prompt manager may then provide, based on the language model output, a notification to a user associated with at least one network-connected device. Through such a technique, the prompt manager can improve user experience and facilitate user proactiveness managing their network of network-connected devices.

In aspects, a method is disclosed that includes a prompt manager obtaining metadata associated with a network of two or more network-connected devices and selecting a templated prompt from a list of one or more templated prompts. Each templated prompt of the one or more templated prompts includes two or more words arranged within at least one sentence fragment. The prompt manager further integrates at least portions of data from the obtained metadata into the selected templated prompt sufficient to produce an instantiated prompt. The instantiated prompt includes the two or more words and the at least portions of data arranged within at least one sentence. Additionally, the prompt manager generates, based on the instantiated prompt and using a language model, a language model output. The prompt manager may then provide, based on the language model output, a notification to a user associated with at least one network-connected device of the two or more network-connected devices. The notification may notify the user of curated information associated with the network of two or more network-connected devices based on the obtained metadata.

This Summary is provided to introduce simplified concepts for autogenerated language model notifications, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for autogenerated language model notifications are described in this document with reference to the following drawings:

FIG. 1 illustrates an example environment in which techniques for autogenerated language model notifications can be implemented;

FIG. 2 illustrates an example operating environment of an example user device capable of implementing aspects of autogenerated language model notifications;

FIG. 3 illustrates an example block diagram directed at implementing autogenerated language model notifications;

FIG. 4 illustrates an example implementation of example templated prompts, example instantiated prompts, and example outputs directed at implementing aspects of autogenerated language model notifications;

FIG. 5 illustrates an example environment in which techniques for autogenerated language model notifications can be implemented; and

FIG. 6 illustrates an example method directed at implementing autogenerated language model notifications.

The use of same numbers in different instances may indicate similar features or components.

### DETAILED DESCRIPTION

### Overview

In the context of smart-homes, including smart-home networks, users often encounter challenges managing and optimizing various network-connected devices (e.g., smart devices). For instance, detailed instructions on how to use smart devices may be overlooked amidst the many tasks, notifications, and interactions within the smart-home environment.

Some smart devices include features for a user to discover on their own or through asking questions on a mobile device. For example, a user may have a new smart entertainment system that they do not know how to integrate into the rest of their smart-home. In such a scenario, the user can input a question into a network-connected device, like their smartphone, to get assistance on how to set up their smart entertainment system. However, the user may not know what to ask for or, simply, may not know that they can ask questions about their new device.

To this end, this document describes techniques and systems for autogenerated language model notifications. The techniques and systems use integrated metadata associated with a user network to autogenerate prompts for a language model. For example, a smart-home device associated with a smart-home network can generate prompts and questions for a user to ask based on previous user interactions, preferences, and other collected user data that a language model analyzes. By so doing, in some cases, the techniques may provide users with relevant notifications to enhance a user's smart-home experience and improve user interactions with smart devices.

### Operating Environment

The following discussion describes an operating environment, techniques that may be employed in the operating environment, and various devices or systems in which components of the operating environment can be embodied. In the context of the present disclosure, reference is made to the operating environment by way of example only.

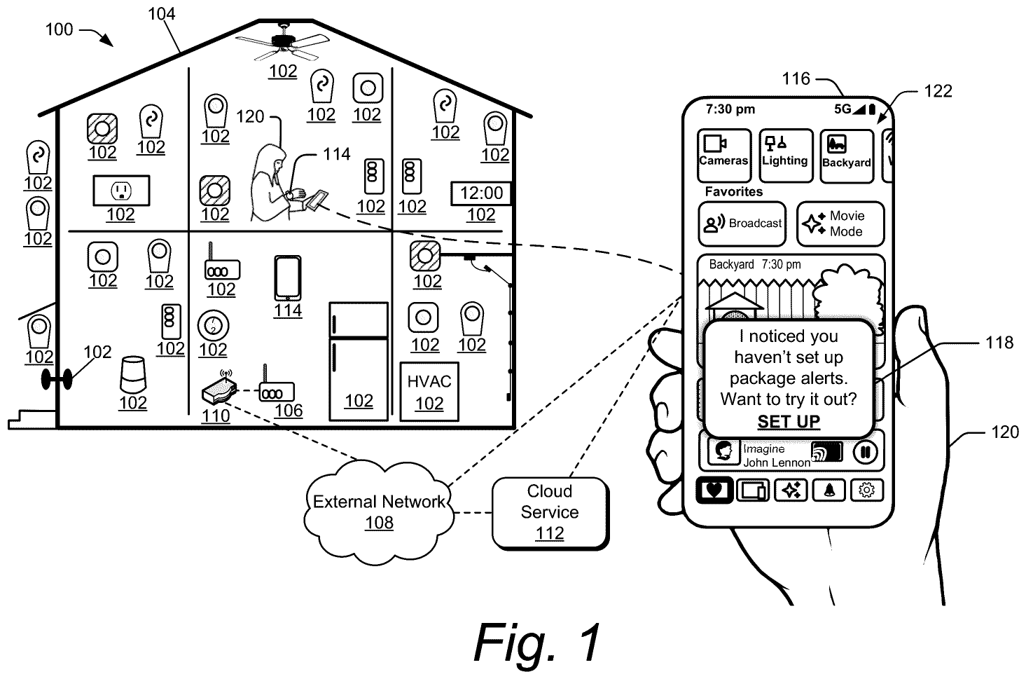

FIG. 1 illustrates an example environment 100 in which a network of network-connected devices and aspects of autogenerated language model notifications can be implemented. Generally, the environment 100 includes the network (e.g., a home area network (HAN)) implemented as part of a home or other type of structure with any number of network-connected devices 102 that are configured for communication in a wireless network. For example, the network-connected devices 102 can include, as non-limiting examples, thermostats, hazard detectors (e.g., for smoke and/or carbon monoxide), cameras (e.g., indoor and outdoor), lighting units (e.g., indoor and outdoor), sensors and detectors (e.g., ambient light detectors, occupancy sensors, doorbells, and door lock system), connected appliances and/or controlled systems (e.g., refrigerators, stoves, ovens, washers, dryers, air conditioners, pool heaters, irrigation systems, and security systems), electronic and computing devices (e.g., televisions, entertainment systems, computers, speakers, intercom systems, garage-door openers, alarm clocks, ceiling fans, and control panels), and any other types of network-connected devices that are implemented inside and/or outside of a structure 104 (e.g., in a home environment).

In the environment 100, any number of the network-connected devices 102 can be implemented for wireless interconnection to wirelessly communicate and interact with each other. The network-connected devices 102 may be modular, intelligent, multi-sensing, wireless devices that can integrate seamlessly with each other and/or with a central server or a cloud-computing system to provide any of a variety of useful automation objectives and implementations. The network-connected devices 102 can also be configured to communicate via the network, which may include a wireless mesh network, a Wi-Fi network, or both.

As described above, the network includes a border router 106 that interfaces for communication with an external network 108, outside the network. The border router 106 connects to an access point 110, which connects to the external network 108, such as the Internet. A cloud service 112, which is connected via the external network 108, may provide services related to and/or using the devices within the network. By way of example, the cloud service 112 can include applications for connecting end-user devices 114, such as smartphones, tablets, wearable devices, and the like, to devices in the network, processing and presenting data acquired in the network to end-users (e.g., as a notification 118), linking devices in one or more networks to user accounts of the cloud service 112, provisioning and updating devices in the network, and so forth. For example, a user 120 can control the network-connected devices 102 in the environment 100 using a network-connected computer or portable device, such as a smartphone 116 (e.g., a mobile phone) or tablet device. Further, the network-connected devices 102 can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

As illustrated, the user 120 can manage, control, and/or view information related to the environment 100 (e.g., smart-home environment), including one or more network-connected devices 102, using a user interface 122 of a device management system presented by a display associated with the smartphone 116. To promote management, control, and/or viewing capabilities of the user 120, the device management system (executing on the cloud service 112, the smartphone 116, and/or another network-connected device 102) may include a prompt manager (not illustrated). The prompt manager may, using metadata associated with the environment 100, generate a notification 118 (e.g., an autogenerated language model notification) that can assist the user 120 in discovering more features and/or information associated with the environment 100, including the network-connected devices 102.

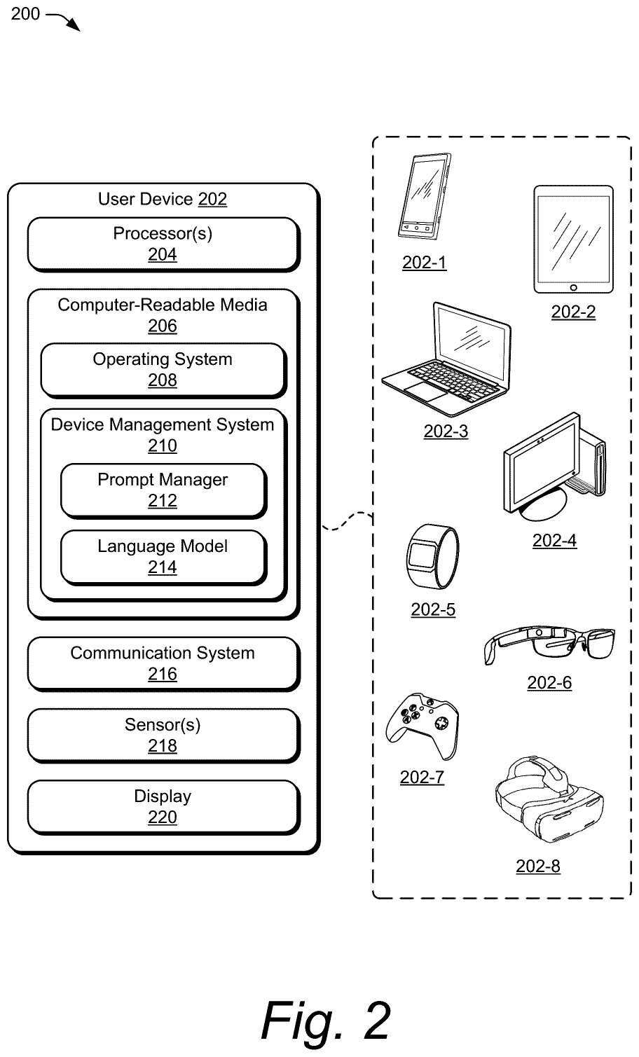

FIG. 2 illustrates an example operating environment 200 that includes an example user device (e.g., smartphone 116) that is capable of implementing aspects of autogenerated language model notifications in accordance with one or more implementations. Examples of a user device 202 include a smartphone 202-1, a tablet 202-2, a laptop 202-3, a desktop computer 202-4, a smart watch 202-5, smart-glasses 202-6, a video game console 202-7, and virtual-reality (VR) goggles 202-8. Although not shown, the user device 202 may also be implemented as any of a mobile station (e.g., fixed- or mobile-STA), a mobile communication device, a client device, a home automation and control system, an entertainment system, a personal media device, a health monitoring device, a drone, a camera, an Internet home appliance capable of wireless Internet access and browsing, an IoT device, security systems, and the like. Note that the user device 202 can be wearable, non-wearable but mobile, or relatively immobile (e.g., appliances). The user device 202 may include components or interfaces omitted from FIG. 2 for the sake of clarity or visual brevity.

As illustrated, the user device 202 includes one or more processors 204 and computer-readable media 206. The processors 204 may include any suitable single-core or multi-core processor (e.g., an application processor (AP), a digital-signal processor (DSP), a central processing unit (CPU), graphics processing unit (GPU)). The processors 204 may be configured to execute instructions or commands stored within computer-readable media 206. The computer-readable media 206 can include an operating system 208 and a device management system 210 (e.g., an application). The device management system 210 includes a prompt manager 212 and a language model 214. In at least some implementations (not illustrated), the device management system 210 does not include the language model 214, and the user device 202 instead accesses a machine-learned model substantially similar to the language model 214 via the cloud service 112. In still further implementations (not illustrated), the device management system 210 and/or the prompt manager 212 can be implemented, partially or completely, on the cloud service 112, the user device 202, and/or any other network-connected device 102 from environment 100.

Applications (not shown) and/or the operating system 208 implemented as computer-readable instructions on the computer-readable media 206 can be executed by the processors 204 to provide some or all of the functionalities described herein. The computer-readable media 206 may be stored within one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The user device 202 may further include and/or be operatively coupled to communication systems 216. The communication systems 216 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of the various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the communication systems 216 may be packetized or framed depending on a communication protocol or standard by which the user device 202 is communicating. The communication systems 216 may include wired interfaces, such as Ethernet or fiber-optic interfaces for communication over a local network, a private network, an intranet, or the Internet. Alternatively or additionally, the communication systems 216 may include wireless interfaces that facilitate communication over wireless networks, such as wireless LANs, cellular networks, or WPANs.

The user device 202 may further include and/or be operatively coupled to one or more sensors 218. The sensors 218 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), or an ambient light sensor (e.g., photodetector). In implementations, the user device 202 includes one or more of a front-facing sensor(s) and a rear-facing sensor(s).

The user device 202 may also include a display 220. In implementations, the user device 202 can present a user interface (e.g., user interface 122) associated with the device management system 210 on the display 220. Using the display 220 and the user interface, the device management system 210 can present notifications (e.g., autogenerated language model notifications) from the prompt manager 212 to a user.

It will be appreciated by one skilled in the art that components and functions described herein may be further divided and/or combined across one or more network-connected devices, including the user device 202, other network-connected devices 102 and/or the cloud service 112.

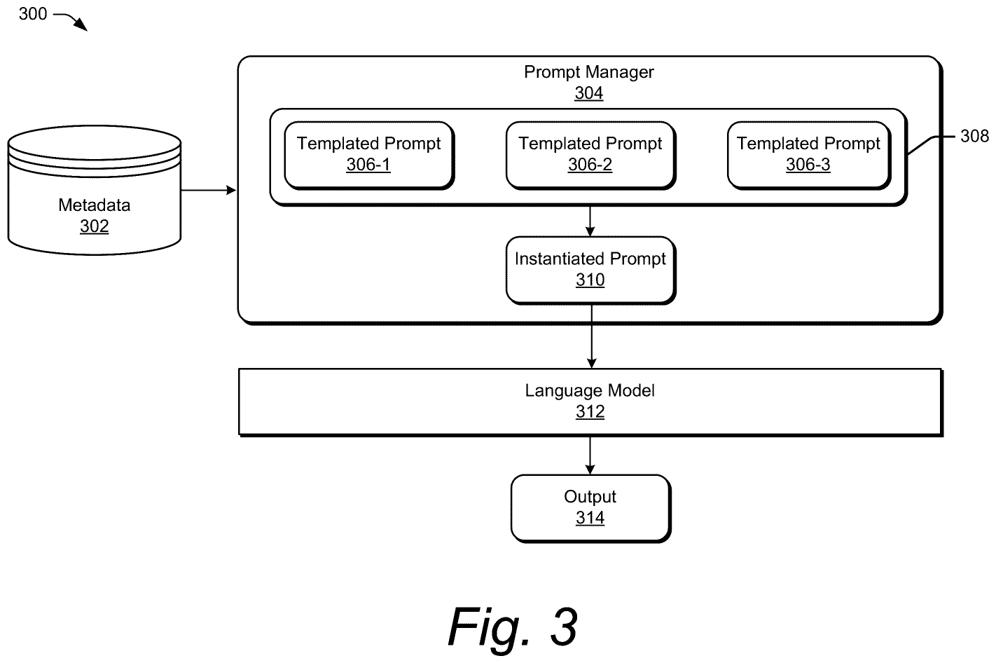

FIG. 3 illustrates an example block diagram 300 directed at implementing autogenerated language model notifications in accordance with one or more implementations. The example block diagram 300 includes metadata 302 associated with a network of two or more network-connected devices, a prompt manager 304, templated prompts 306 (e.g., first templated prompt 306-1, second templated prompt 306-2, third templated prompt 306-3) within a list of templated prompts 308, an instantiated prompt 310, a language model 312, and an output 314. As illustrated, the prompt manager 304 obtains the metadata 302. In some implementations, the metadata 302 can include, but is not limited to, user data collected from a network, information related to one or more network-connected devices, previous prompt history, voice interaction history, user interactions with network-connected devices and/or the device management system 210, a location of the user, and/or any other collected data from the environment 100. In at least some implementations, the prompt manager 304 obtains documentation associated with one or more network-connected devices 102. For example, documentation can include, but is not limited to, information provided by device manufacturers, device specifications, device compatibility/integration requirements, device network protocols, device privacy settings, and/or device setup instructions.

Further, the prompt manager 304 maintains (e.g., within the list of templated prompts 308) the templated prompts 306. The templated prompts 306 may include, as non-limiting examples, a feature discovery prompt (e.g., first templated prompt 306-1), an automation creation prompt (e.g., second templated prompt 306-2), and/or a suggestion prompt (e.g., third templated prompt 306-3). From the list of templated prompts 308, the prompt manager 304 selects one of the templated prompts 306 to create the instantiated prompt 310. For example, based on the metadata 302, the prompt manager 304 can select the first templated prompt 306-1, which may be a feature discovery prompt. The prompt manager 304 can then integrate (e.g., fuse) portions of data from the metadata 302 into the first templated prompt 306-1 to create the instantiated prompt 310. The prompt manager 304 can further transmit the instantiated prompt 310 to the language model 312.

In some implementations, the language model 312 may be an on-device language model. For example, the language model may operate on a local server. In such an implementation, user privacy may be prioritized and latency of model outputs may be reduced. A user with an on-device language model may appreciate the efficiency and personalization of the model. In additional implementations, the language model 312 may operate on a cloud service (e.g., cloud service 112). For example, a language model operating on a cloud service may process all user interactions with, behaviors associated with, and/or patterns for one or more network-connected devices. In implementations, the language model 312 may be a machine-learned model that recognizes patterns based on inputted data. For example, the inputted data may be structured data (e.g., comma-separated values (CSV), extensible markup language (XML), etc.) or data embedded in natural language (e.g., sentences, fragments, lists). In additional implementations, the language model 312 can be a large language model. The language model 312 may produce an output 314. The output 314 may be generated in response to receipt of the instantiated prompt 310.

In further implementations, the prompt manager 304 detects an initiation event before it selects a templated prompt 306 from the list of the templated prompts 308. Thus, in at least some instances, the selection of a templated prompt 306 from the list of templated prompts 308 is based on the detection of a given initiation event. For example, the initiation event can be the identification of a pattern within the metadata 302. The identification of a pattern can be performed by a machine-learned model, which recognizes patterns within the metadata 302 over a duration of time. As another example, the initiation event can be an expiration of time since a trigger event. In one example, the trigger event can be the activation of a network-connected device or an addition of a network-connected device to the network and/or environment 100. In this instance, for example, the initiation event may be the expiration of a month since a user added a new smart thermostat to their smart-home network. As another example, the initiation event can be an interaction by a user with a network-connected device, such as when a user turns on their smart television or accesses the application interface of any of their network-connected devices. In a still further example, the initiation event can be an interaction by a user with information associated with a network-connected device, such as when a user accesses the settings to their smart lightbulbs on their mobile device. In response to at least one of the example initiation events, the prompt manager 304 may select one of the templated prompts 306 to be integrated with the metadata 302 to become the instantiated prompt 310.

In implementations, the templated prompt 306-1 can be a feature discovery prompt. Relevant portions of the metadata 302 can be integrated (e.g., templated) into the feature discovery prompt. In some implementations, the relevant portions of data can be related to a network-connected device that a user has recently interacted with, a network-connected device that was recently activated, or a network-connected device recently added to a user network as indicated by the metadata 302. The integration of the metadata 302 into the templated feature discovery prompt then produces an instantiated feature discovery prompt (e.g., the instantiated prompt 310) that has been filled in with at least portions of the metadata 302. For example, a templated feature discovery prompt can include “Inform user they have not used [features] for their [network-connected device] yet.” Based on relevant obtained user data, the templated feature discovery prompt can be filled in to produce the instantiated feature discovery prompt. For example, the instantiated feature discovery prompt may include “Inform user they have not used inventory management and recipe suggestion features for their smart refrigerator.” The prompt manager 304 may then transmit the instantiated feature discovery prompt to the language model 312, which may generate an output 314. The output 314 may include a notification. For example, the prompt manager 304 may cause the notification to be presented on the display 220 and include “You have not used inventory management and recipe suggestion features for your smart refrigerator. Would you like to learn more?” The user may then be provided with a push button and/or link enabling them to learn more about their smart refrigerator features.

In additional implementations, the templated prompt 306-2 can be an automation creation prompt. Relevant portions of the metadata 302 can be integrated (e.g., templated) into the automation creation prompt. In some implementations, the relevant portions of data can be related to a network-connected device that a user has recently interacted with, a network-connected device that was recently activated, or a network-connected device recently added to a user network as indicated by the metadata 302. The integration of the metadata 302 into the templated automation creation prompt then produces an instantiated automation creation prompt (e.g., the instantiated prompt 310) that has been filled in with at least portions of the metadata 302. As an example, a templated automation creation prompt may include “You are recommending the creation of the following automation: adjust [device n+1] to [setting] when [device y] connects to network or is in proximity to environment 100.” Based on relevant obtained user data, the templated automation creation prompt can be filled in to produce the instantiated automation creation prompt. For example, the instantiated automation creation prompt may include “You are recommending the creation of the following automation: adjust entryway lights to full brightness when user's smartphone connects to network or is in proximity to environment 100.”

When the prompt manager 304 transmits the instantiated automation creation prompt to the language model 312, which is discussed in greater detail below, the language model 312 may generate an output 314. The output 314 may include a notification having an automation routine toggle button. For example, the prompt manager 304 may cause the notification to be presented on the display 220 and include “Would you like to adjust entryway lights to full brightness when you arrive home?” The user may then be provided with a toggle button enabling them to activate this automation routine. As demonstrated in the above examples, an automation may include a routine, function, and/or operation of one or more network-connected devices, which may be triggered by at least one predefined condition.

In still further implementations, the templated prompt 306-3 can be a suggestion prompt. The relevant portions of the metadata 302 can be integrated (e.g., templated) into the suggestion prompt. The suggestion prompt can be a response to a question provided by a user seeking a suggestion for information related to a network-connected device. The relevant portions of data can be related to the usage habits or activities of the user as indicated by the metadata 302. The integration of the metadata 302 into the templated suggestion prompt then produces an instantiated suggestion prompt (e.g., the instantiated prompt 310) that has been filled in with at least portions of the metadata 302. Based on relevant obtained user data and a query from the user (e.g., an initiation event), the templated suggestion prompt can be filled in to produce the instantiated suggestion prompt. For example, a query from the user can include “Suggest an automation I would like?” In response to the query, the prompt manager 304 may select a templated suggestion prompt, which may include “Provide a recommendation to adjust [recently added device] to [user favorite setting] upon [condition].” Based on the metadata 302, the prompt manager 304 may fill the templated suggestion prompt with relevant data about the user's new device (e.g., a smart blind system), favorite settings (e.g., closing the blinds), and time of day preferences (e.g., sunset).

As another example, a query from a user can include “Give me a question I can ask.” As a response to the query, the prompt manager 304 may select another templated suggestion prompt, which may include “Provide a question about [recently activated device] functionality during [condition].” Based on the metadata 302, the prompt manager 304 may fill in the templated suggestion prompt with relevant data about the user's recently activated device (e.g., a smart speaker) and activity preferences (e.g., listening to music) to create an instantiated suggestion prompt. The prompt manager 304 may then transmit the instantiated suggestion prompt to the language model 312, which may generate an output 314. The output 314 may include a notification having a suggestion toggle button. For example, the prompt manager 304 may cause the notification to be presented on the display 220 and include “What settings can I explore on my smart speaker to enhance my music listening experience?” The notification may provide a text input box enabling the user to ask the question.

Different initiation events may cause the prompt manager 304 to select identical templated prompts 306 from the list of templated prompts 308. For example, the prompt manager 304 can select a feature discovery prompt if the prompt manager 304 detects the expiration of two weeks since when a user added a smart speaker to their smart-home network. In another example, the prompt manager 304 can select a feature discovery prompt if the prompt manager 304 detects that a user has turned on their smart speaker.

In aspects, the prompt manager 304 transmits the instantiated prompt 310 to the language model 312, which causes the language model 312 to produce the output 314. The prompt manager 304 may ensure that the output 314 is appropriate for the user by filtering out poor responses to the instantiated prompt 310. For example, the prompt manager 304 may utilize another machine-learned model to filter responses. In at least some implementations, the prompt manager 304 can direct the language model 312 to add deep links for device settings as part of the output 314. In further implementations, the prompt manager 304 can direct the language model 312 to surface device settings and controls directly onto an interface (e.g., user interface 122) as part of the output 314. In aspects, the output 314 can be a response to a feature discovery prompt, a response to an automation creation prompt, or a response to a suggestion prompt.

In some implementations, the output 314 can be a push notification presented on the display 220 of the user device 202. For example, a user may have recently added a smart speaker to their smart-home network. Metadata 302 may indicate the recent addition of the smart speaker to the network, and the prompt manager 304 may identify this addition as an initiation event. Based on the initiation event, the prompt manager 304 may select a templated feature discovery prompt (e.g., templated prompt 306-1) and integrate at least portions of data from the metadata 302. In response to the prompt manager 304 integrating at least portions of data into the templated feature discovery prompt, the prompt manager 304 may produce an instantiated feature discovery prompt (e.g., instantiated prompt 310). The prompt manager 304 may transmit the instantiated feature discovery prompt to the language model 312, which may produce the output 314. The user may then receive a push notification, including the output 314, with information about their new device on their user device (e.g., smartphone 116). The push notification may indicate that the new smart speaker can play music, set alarms, or control other network-connected devices. The push notification may further provide the user with a deep link to the smart speaker settings and show the user an overview of smart speaker features. The user can interact with the notification to go to the smart speaker settings and learn more about their new device. In aspects, the push notification to the user can be, but is not limited to, an email, a text message, a pop-up notification, an audible message, or a Google Home application (GHA) Feedcard. The push notification may include an audio and/or a visual output. The push notification may further be configured to receive user input (e.g., buttons, swipe input, audible input). As described herein, the output 314 (e.g., a push notification) may be referred to as an autogenerated language model notification.

In implementations, the output 314 can be an autocompletion to a command with an automation creation prompt. Consider another example of a user who has a smart-home network with several network-connected devices. This comprehensive network may include a smart light system, a smart coffee maker, and a smart thermostat. Based on a few days of collecting user data, a machine-learned model (e.g., language model 312) may recognize a pattern of the user's morning routine. In response to the user typing out a command on their user device (e.g., smartphone 116), a prompt manager (e.g., prompt manager 304) can provide an automation creation prompt integrated with portions of user metadata (e.g., metadata 302). As an example, the user can start their command with “every day at 7:00 AM” which may lead the prompt manager to autocomplete the command with “adjust kitchen lights to 100% brightness, start brewing coffee in coffee maker, and set living room temperature to 72 degrees Fahrenheit.” If the user decides to engage with the prompt, the automation can be set throughout the smart-home network.

In implementations, the output 314 can be a suggested question or automation idea in response to a user asking for a suggestion prompt. For example, consider a user who recently activated their network-connected smart entertainment system. This user may have owned their smart entertainment system for a couple months, but never learned the full functionalities of their smart entertainment system. The user may decide to learn more about their smart entertainment system by providing the following command to their user device 202: “suggest a question I should ask.” A prompt manager (e.g., prompt manager 304) can use the prior voice interaction history, prior user question history, commonly asked questions from other users, and/or similar user data to provide a suggestion prompt. As an example, the prompt manager can tell the user to ask questions such as “Can I use voice commands to control the entertainment system?” or “What streaming services are available through the entertainment system?” In addition, the user can also type a command such as “suggest an automation I would like” and the prompt manager can use portions of metadata (e.g., metadata 302) relevant to the smart entertainment system to provide another suggestion prompt. The prompt manager can autogenerate a prompt for automating a movie night, where the smart thermostat is set to the user's preference, the smart blinds are closed, and the ambient lighting is dimmed, with every setting based on how the user has watched movies in the past, or how similar users have adjusted their settings.

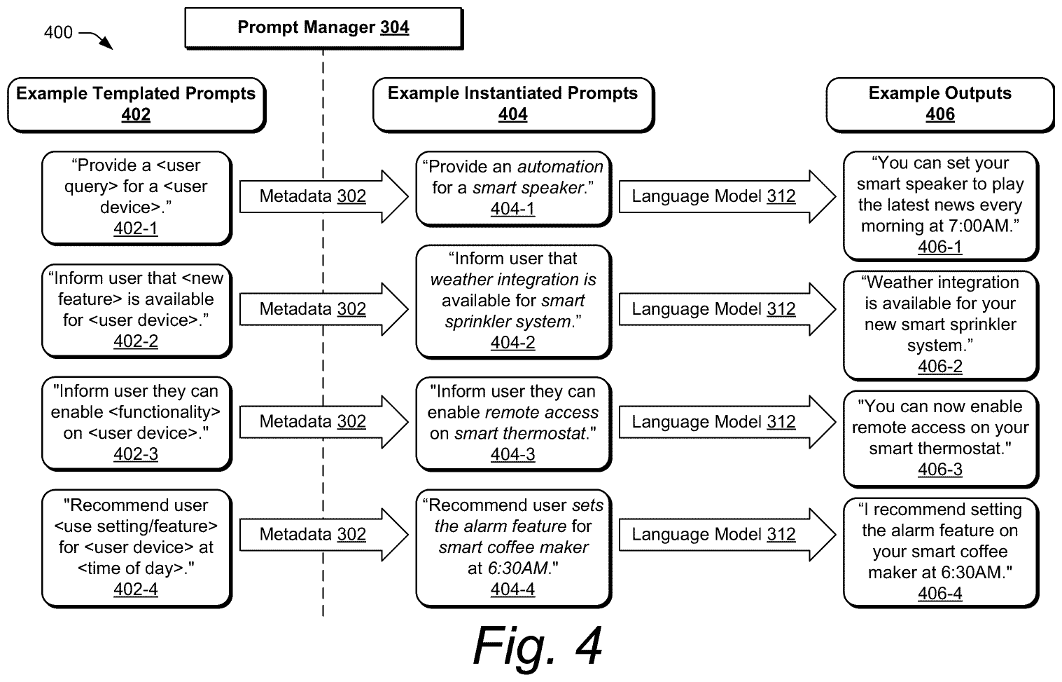

FIG. 4 illustrates an example implementation 400 of example templated prompts 402, example instantiated prompts 404, and example outputs 406. The example implementation 400 includes four instances of example templated prompts 402 (e.g., first example templated prompt 402-1, second example templated prompt 402-2, third example templated prompt 402-3, fourth example templated prompt 402-4). The example implementation 400 further includes four instances of example instantiated prompts 404 (e.g., first example instantiated prompt 404-1, second example instantiated prompt 404-2, third example instantiated prompt 404-3, fourth example instantiated prompt 404-4). The example implementation additionally includes four instances of example outputs 406 (e.g., first example output 406-1, second example output 406-2, third example output 406-3, fourth example output 406-4). The example implementation 400 also includes the metadata 302, the prompt manager 304, and the language model 312. In implementations, the prompt manager 304 obtains the metadata 302 (see FIG. 3) and integrates at least portions of data from the metadata 302 in the example templated prompts 402. In response to the prompt manager 304 integrating at least portions of data from the metadata 302 into the example templated prompts 402, the prompt manager 304 produces the example instantiated prompts 404. The prompt manager 304 then transmits the example instantiated prompts 404 to the language model 312. In response to receiving the example instantiated prompts 404, the language model 312 produces the example outputs 406.

In implementations, a respective example templated prompt 402 may include one or more tokens. Tokens may include words, numbers, characters (e.g., American Standard Code for Information Exchange (ASCII)), and/or sequences of characters. In at least some implementations, the one or more tokens are arranged together to form a sentence fragment (e.g., one or more words that do not express a complete thought or idea, a grouping of words that lack a subject, a verb, or both). As illustrated in FIG. 4, the example templated prompts 402 do not express a complete thought, and instead have spaces for the prompt manager 304 to fill in words and/or values based on portions of data from the metadata 302. In some examples, the example instantiated prompts 404 can include a standalone sentence, phrase, or list of words.

In one example, the example templated prompt 402-1 may be an example of a templated suggestion prompt, and the example instantiated prompt 404-1 may be an example of an instantiated suggestion prompt. For instance, the prompt manager 304 may obtain metadata 302 about a user's smart speaker. In response to a user inputting (e.g., typing, speaking) a query into their user device 202, the prompt manager 304 may use the query and portions of metadata 302 to fill out the templated prompt 402-1 and produce the instantiated prompt 404-1. The prompt manager 304 may further transmit the instantiated prompt 404-1 to the language model 312. The language model 312 may produce an example output 406-1, which may be an example of a notification sent to a user about their smart speaker.

In another example, the example templated prompt 402-2 may be an example of a templated feature discovery prompt, and the example instantiated prompt 404-2 may be an example of an instantiated feature discovery prompt. For instance, the prompt manager 304 may obtain metadata 302 about a user's smart sprinkler system. In response to an initiation event (e.g., a network-connected device added to a network), the prompt manager 304 may use portions of metadata 302 (e.g., new features) to fill out the templated prompt 402-2 and produce the instantiated prompt 404-2. The prompt manager 304 may further transmit the instantiated prompt 404-2 to the language model 312. The language model 312 may produce an example output 406-2, which may be an example of a notification sent to a user about their smart sprinkler system.

In a still further example, the example templated prompt 402-3 may be an example of a templated feature discovery prompt, and the example instantiated prompt 404-3 may be an example of an instantiated feature discovery prompt. For instance, the prompt manager 304 may obtain metadata 302 about a user's smart thermostat. In response to an initiation event (e.g., user interaction with a network-connected device), the prompt manager 304 may use portions data from the metadata 302 (e.g., new functionalities) to fill out the templated prompt 402-3 and produce the instantiated prompt 404-3. The prompt manager 304 may further transmit the instantiated prompt 404-3 to the language model 312. The language model 312 may produce an example output 406-3, which may be an example of a notification sent to a user about their smart thermostat.

In a further example, the example templated prompt 402-4 may be an example of a templated automation creation prompt, and the example instantiated prompt 404-4 may be an example of an instantiated automation creation prompt. For instance, the prompt manager 304 may obtain metadata 302 about a user's smart coffee maker and user interactions with the smart coffee maker. In response to an initiation event (e.g., identification of a pattern), the prompt manager 304 may use portions of metadata 302 (e.g., past settings and times) to fill out the templated prompt 402-4 and produce the instantiated prompt 404-4. The prompt manager 304 may further transmit the instantiated prompt 404-4 to the language model 312. The language model 312 may produce an example output 406-4, which may be an example of a notification sent to a user about their smart coffee maker.

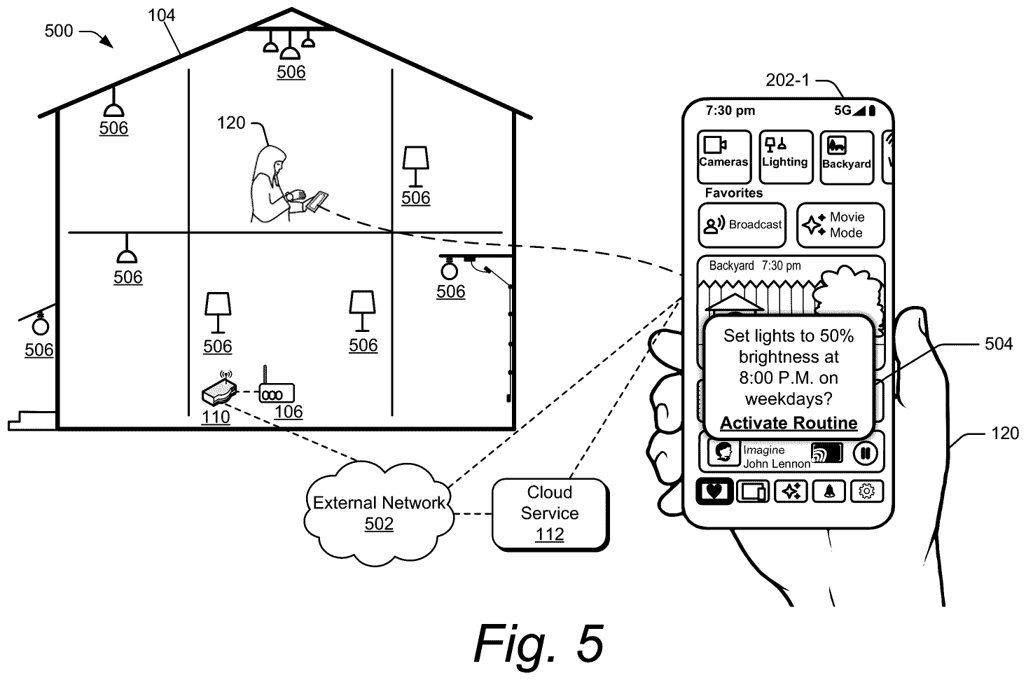

FIG. 5 illustrates an example environment 500 in which aspects of autogenerated language model notifications can be implemented. As illustrated, the environment 500 includes the structure 104, an external network 502, a notification 504, network-connected lighting devices 506, the border router 106, the access point 110, the cloud service 112, the smartphone 202-1, and the user 120. In implementations, the external network 502 and/or the smartphone 202-1, via the device management system 210 (not illustrated), may operatively communicate with the cloud service 112. The device management system may include a prompt manager (e.g., prompt manager 304) and/or a language model (e.g., language model 312) (not illustrated). The prompt manager, using metadata (e.g., metadata 302) associated with the environment 500, may utilize the language model to generate a notification 504 (e.g., an autogenerated language model notification), which can assist the user 120 in managing the environment 500.

In some implementations, the prompt manager may determine and implement a time delay before generating and/or presenting an output (e.g., output 314), the notification 504, or both. The time delay may be determined based at least in part on the metadata 302. For example, the time delay may be based on any one of a location of the user 120, an activity of the user 120, a number of notifications on the smartphone 202-1, an operating state of the smartphone 202-1, or a power level of the smartphone 202-1. In one example, the user 120 may go to work every morning and come back home (e.g., structure 104) every evening. When the user 120 comes home, they may like to set their smart lights to a brightness of 100%. A machine-learned model may recognize this pattern, which may trigger a prompt manager to direct the model to produce an output. However, the prompt manager may set a time delay before generating a notification to the user 120 because the pattern indicates that the brightness levels change only after the user 120 arrives home. Thus, when the user 120 arrives home, the prompt manager may generate the notification because the time delay has expired.

In another example, the user 120 may like to set their smart lights to 50% around 8:00 PM every evening on weekdays. A machine-learned model may recognize this pattern, which may trigger a prompt manager to direct the model to produce an output. However, the prompt manager may set a time delay before generating a notification (e.g., notification 504) to the user 120 because the pattern indicates that the brightness levels change only after 8:00 PM on weekdays. Thus, when it reaches 8:00 PM, the prompt manager may generate the notification to the user 120 because the time delay expired when it reached 8:00 PM.

Further to the descriptions above, a user may be provided with controls allowing the user to make an election as to both if and when systems, programs, or features described herein may enable collection of user information (e.g., information about a user's social network, social actions, social activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over what information is collected about the user, how that information is used, and what information is provided to the user.

### Example Methods

The method 600 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

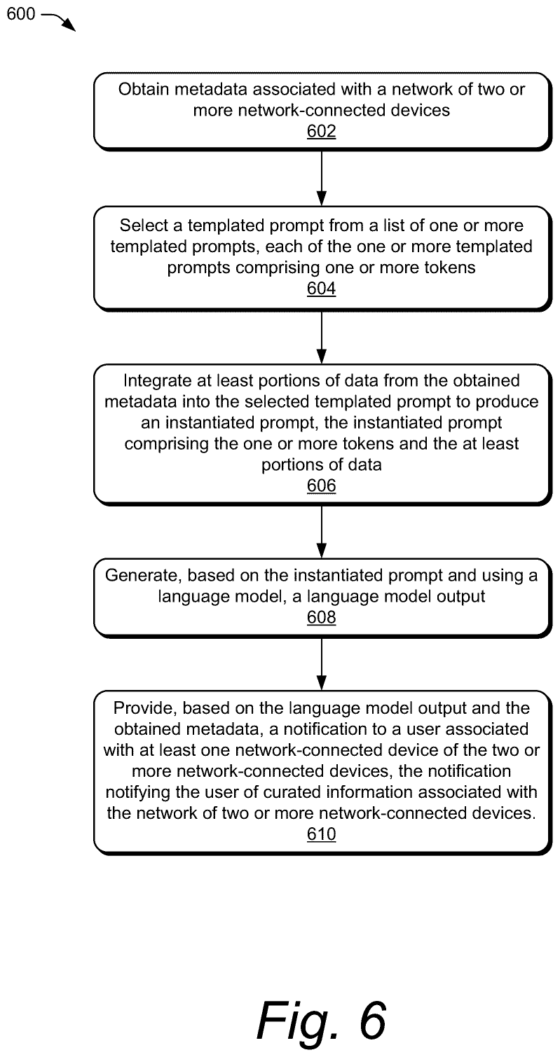

FIG. 6 illustrates an example method 600 for autogenerating language model notifications in accordance with one or more implementations. At 602, metadata associated with a network of two or more network-connected devices is obtained. The metadata may include, but is not limited to, user data collected from a network, information related to one or more network-connected devices, previous prompt history, voice interaction history, user interactions with network-connected devices and/or a device management system (e.g., device management system 210), location of the user, and/or any other collected data from a user environment. In at least some implementations, a prompt manager (e.g., prompt manager 304) may obtain the metadata (e.g., metadata 302) before the prompt manager selects a templated prompt.

At 604, a templated prompt from a list of one or more templated prompts is selected. Each templated prompt of the one or more templated prompts may include one or more tokens (e.g., arranged within at least one sentence fragment). For example, the prompt manager may select a templated prompt (e.g., templated prompt 306) from three templated prompts (e.g., first templated prompt 306-1, second templated prompt 306-2, third templated prompt 306-3). The selection may be based on the obtained metadata.

At 606, at least portions of data from the obtained metadata is integrated (e.g., templated) into the selected templated prompt to produce an instantiated prompt. The instantiated prompt may include the one or more tokens and the at least portions of data. For example, the prompt manager can integrate the metadata into templated prompts (e.g., example templated prompts 402) to produce an instantiated prompt (e.g., example instantiated prompts 404).

At 608, a language model output is generated based on the instantiated prompt and using a language model. For example, the prompt manager may transmit the instantiated prompt to a language model (e.g., language model 312) to generate an output (e.g., output 314).

At 610, the prompt manager may provide a notification to a user associated with at least one network-connected device of the two or more network-connected devices based on the language model output. The notification may notify the user of curated information associated with the network of two or more network-connected devices based on the obtained metadata. For example, a user may receive a notification (e.g., notification 504) with information relevant to the user based on an environment (e.g., environment 100) and the metadata.

### CONCLUSION

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of autogenerated language model notifications have been described in language specific to techniques and/or systems, it is to be understood that the subject of the appended claims is not necessarily limited to the specific techniques or methods described. Rather, the specific techniques and methods are disclosed as example implementations for autogenerated language model notifications.

What is claimed is:

1. A method comprising:
obtaining metadata associated with a network of two or more network-connected devices;
selecting a templated prompt from a list of one or more templated prompts, each of the one or more templated prompts comprising one or more tokens;
integrating at least portions of data from the obtained metadata into the selected templated prompt sufficient to produce an instantiated prompt, the instantiated prompt comprising the one or more tokens and the at least portions of data;
generating, based on the instantiated prompt and using a language model, a language model output; and
providing, based on the language model output and the obtained metadata, a notification to a user associated with at least one network-connected device of the two or more network-connected devices, the notification notifying the user of curated information associated with the network of two or more network-connected devices.

2. The method of claim 1, further comprising:
detecting, prior to selecting the templated prompt, an initiating event, the initiating event comprising at least one of an identification of a pattern within the metadata, an expiration of time since a trigger event, an interaction by the user with a network-connected device of the two or more network-connected devices, or an interaction by the user with information associated with a network-connected device of the two or more network-connected devices.

3. The method of claim 2, wherein the detecting of the initiating event comprises the identification of the pattern within the metadata, the identification comprising a machine-learned model recognizing the pattern over a duration of time.

4. The method of claim 2, wherein the detecting of the initiating event comprises the expiration of time since the trigger event, the trigger event comprising an activation of a network-connected device of the two or more network-connected devices or an addition of a network-connected device to the network of two or more network-connected devices.

5. The method of claim 2, wherein the detecting of the initiating event comprises the interaction by the user with the network-connected device, the interaction comprising an engagement by the user with an application interface associated with the network of two or more network-connected devices on the network-connected device.

6. The method of claim 1, wherein the list of one or more templated prompts comprise a feature discovery prompt, and wherein:
selecting the templated prompt from the list of one or more templated prompts comprises selecting the feature discovery prompt; and
integrating at least portions of data from the metadata into the selected templated prompt comprises integrating at least portions of data into the feature discovery prompt that are relevant to features associated with a network-connected device that a user has recently interacted with, a network-connected device that was recently activated, or a network-connected device that was recently added to the network of two or more network-connected devices.

7. The method of claim 1, wherein the list of one or more templated prompts comprise an automation creation prompt, and wherein:
selecting the templated prompt from the list of one or more templated prompts comprises selecting the automation creation prompt; and
integrating at least portions of data from the metadata into the selected templated prompt comprises integrating at least portions of data into the automation creation prompt that are relevant to automation routines available with a network-connected device that a user has recently interacted with, a network-connected device that was recently activated, or a network-connected device that was recently added to the network of two or more network-connected devices.

8. The method of claim 1, wherein the list of one or more templated prompts comprise a suggestion prompt, and wherein:
selecting the templated prompt from the list of one or more templated prompts comprises selecting the suggestion prompt; and
integrating at least portions of data from the metadata into the selected templated prompt comprises integrating at least portions of data into the suggestion prompt that are in response to a query provided by a user and relevant to usage habits or activities of the user as indicated by the obtained metadata.

9. The method of claim 8, wherein the query provided by the user comprises a question that seeks a suggestion for information associated with at least one network-connected device of the two or more network-connected devices.

10. The method of claim 1, wherein the notification comprises at least one of an audio output or a visual output.

11. The method of claim 1, further comprising:
determining, based on the obtained metadata and prior to providing the notification to the user, a time delay between the generating of the language model output and the providing of the notification; and
delaying, in response to the generating of the language model output, the providing of the notification in accordance with the determined time delay.

12. The method of claim 11, wherein the determining of the time delay is based on at least one of a location of the user, an activity of the user, a number of notifications on the at least one network-connected device, an operating state of the at least one network-connected device, or a power level of the at least one network-connected device.

13. The method of claim 1, further comprising:
obtaining, prior to the integrating of at least portions of data from the obtained metadata into the selected templated prompt, documentation associated with a network-connected device of the two or more network-connected devices.

14. The method of claim 1, wherein the notification comprises a pop-up notification, a text message, or an email.

15. The method of claim 1, wherein the one or more tokens comprise letters, and the letters are arranged within at least one sentence fragment in the selected templated prompt.
